(19) United States
(12) Patent Application Publication
(10) Pub. No.: US 2024/0292991 A1
(43) Pub. Date: Sep. 5, 2024

(54) METHOD AND SYSTEM FOR DETECTING FLOOR STAINS USING SURROUND VIEW IMAGES

(71) Applicant: L&T TECHNOLOGY SERVICES LIMITED, Chennai (IN)

(72) Inventors: MANJU S HATHWAR, Mysuru (IN); J FRENSIC PREM KUMAR, Bengaluru (IN); ARNAB GHOSH, Kolkata (IN); UJWALA SANKH, Vijayapura (IN); SAHANA N, Bangalore (IN); KIRAN METI, Bagalkot (IN)

(21) Appl. No.: 18/230,685

(22) PCT Filed: Jun. 8, 2022
(86) PCT No.: PCT/IB2022/055312

§ 371 Date: Aug. 7, 2023

(30) Foreign Application Priority Data
Jun. 8, 2021 (IN) 202141025477

(51) Int. Cl. A47L 11/40

(52) U.S. Cl. CPC A47L 11/4011; A47L 11/4008

(57) ABSTRACT

A method for detecting floor stains is disclosed. The method includes capturing images of a floor surface using one or more image capturing devices mounted on exterior top sides of the floor cleaning device body aimed in a forward drive direction. The images correspond to wide-angle view images. The method includes generating undistorted virtual top view image of the floor surface. The undistorted virtual top view image corresponds to a surround view image of the floor surface. The method includes detecting floor stain from undistorted virtual top view image using a first pre-trained machine learning model. The method includes processing floor stain to extract floor stain attribute. The floor stain attribute comprises at least one of: dimensions, type of floor stain, a distance of floor stain from image capturing devices, and a location of floor stain. The method includes cleaning floor stain based on the processing of the floor stain.

### TECHNICAL FIELD

This disclosure relates generally to computer vision, and more particularly to a system and a method for detecting floor stains from surround view images using artificial intelligence.

### BACKGROUND

Floor stains are the defects to be detected and cleaned by floor cleaning equipment. Some of this equipment are often vehicles with wheels and a human driver seat. A human operator of such floor cleaning vehicles maneuvers the vehicle over the defects. When the floor stains are detected, operator has machine controls that activate the cleaning brushes on the stains. Human efforts to detect floor stains are not automated and are error prone resulting in stains being left over even as the cleaning vehicle passes over them. Various techniques have been tried and has been an active research area to detect and clean floor stains using computer vision and image processing techniques. However, the problems associated with such techniques are sensing distance and coverage area is not correct, sensors or usual camera system are unable to capture defect in their proper dimensions, training sensors/algorithms need to distinguish clean and unclean floor, needs to distinguish between defects and floor texture, cannot retrofit in existing machines without mechanical modifications.

Accordingly, there is a need for a system and method for detecting floor stains accurately to clean floor surface.

### SUMMARY OF THE INVENTION

In an embodiment, a method for detecting floor stains using surround view images is disclosed. The method may include capturing, by a floor cleaning device, a plurality of images of a floor surface using one or more image capturing devices mounted on exterior top sides of the floor cleaning device body aimed in a forward drive direction, wherein the plurality of images correspond to a plurality of wide-angle view images. The method may further include generating, by the floor cleaning device, at least one undistorted virtual top view image of the floor surface using the plurality of images captured of the floor surface, wherein the at least one undistorted virtual top view image corresponds to a surround view image of the floor surface. The method may further include detecting, by the floor cleaning device, at least one floor stain from the at least one undistorted virtual top view image of the floor surface using a first pre-trained machine learning model, wherein a canvas area of the at least one undistorted virtual top view image has a predefined ratio relative to a floor area covered by the one or more image capturing devices. The method may further include processing, by the floor cleaning device, the at least one floor stain to extract at least one floor stain attribute from one or more floor stain attributes. In accordance with an embodiment, the one or more floor stain attributes comprise: dimensions of the floor stain, a floor stain type from a set of floor stain types, a distance of the at least one floor stain from each of the one or more image capturing devices, and a location of the at least one floor stain in the floor area. The method may further include cleaning, by the floor cleaning device, of at least one floor stain based on the processing of the least one floor stain.

In an embodiment, a system for detecting floor stains using surround view images is disclosed. The system comprises a processor and a memory communicatively coupled to the processor. The memory stores processor-executable instructions, which, on execution, causes the processor to capture a plurality of images of a floor surface using one or more image capturing devices mounted on exterior top sides of the floor cleaning device body aimed in a forward drive direction, wherein the plurality of images correspond to a plurality of wide-angle view images. The processor-executable instructions, on execution, further causes the processor to generate at least one undistorted virtual top view image of the floor surface using the plurality of images captured of the floor surface, wherein the at least one undistorted virtual top view image corresponds to a surround view image of the floor surface. The processor-executable instructions, on execution, further causes the processor to detect at least one floor stain from the at least one undistorted virtual top view image of the floor surface using a first pre-trained deep learning model, wherein a canvas area of the at least one undistorted virtual top view image has a predefined ratio relative to a floor area covered by the one or more image capturing devices. The processor-executable instructions, on execution, further causes the processor to process the at least one floor stain to extract at least one floor stain attribute from one or more floor stain attributes. In accordance with an embodiment, the one or more floor stain attributes comprise: dimensions of the floor stain, a floor stain type from a set of floor stain types, a distance of the at least one floor stain from each of the one or more image capturing devices, and a location of the at least one floor stain in the floor area. The processor-executable instructions, on execution, further causes the processor to clean at least one floor stain based on the processing of the least one floor stain.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a schematic diagram of a floor cleaning device for detecting floor stains using surround view images, in accordance with an embodiment of the present disclosure.

FIG. 2 is a functional block diagram of a floor cleaning device for detecting floor stains using surround view images, in accordance with an embodiment of the present disclosure.

FIG. 3A-3B illustrate an exemplary scenario of capturing plurality of wide-angle view images and generating undistorted virtual top view image of the floor surface for detecting floor stains, in accordance with an embodiment of the present disclosure.

FIG. 4A-4C collectively illustrate an exemplary scenario of floor cleaning device used for extracting floor stain attributes, in accordance with an embodiment of the present disclosure.

FIG. 5 is a flowchart that illustrates an exemplary method for detecting floor stains using surround view images, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The following described implementations may be found in the disclosed method and system for detecting floor stains using computer vision and Artificial Intelligence (AI). The disclosed system (referred as a floor cleaning device or a vehicle) may use a deep learning model, such as, but not limited to, object detection based Convolutional Neural Network (CNN) model, and a Support Vector Machine (SVM) classification-based machine learning model. Exemplary aspects of the disclosure may provide for detecting and identifying floor stain using bird eye view generation and object analytics.

Exemplary aspects of the disclosure may provide a plurality of image capturing devices (such as, 3-camera system) that generates Bird Eye View with 180-degree Coverage each camera. In accordance with an embodiment, the Bird Eye View enables to see the defects, stains on floor surface in true dimensions (such as, cm, mm) and compute distance between the floor stain and camera. In accordance with an embodiment, defects, and stains on the floor surface can be analyzed by the floor cleaning device with Surround View images using object analytics for classification. The disclosed floor cleaning device may increase work efficiency in floor cleaning device and also automate some of the work in floor cleaning by reliably identifying floor stain defects left over by operator or human errors.

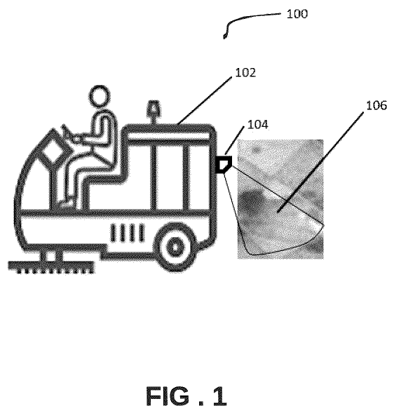

FIG. 1 is a schematic diagram of a floor cleaning device for detecting floor stains using surround view images, in accordance with an embodiment of the present disclosure.

Referring to FIG. 1, a representative picture of floor cleaning device with indicative placement of front looking ultra-wide-angle fish eye (180-degree Camera) is illustrated.

The schematic diagram 100 of the floor cleaning device 102 includes one or more image capturing devices 104. The floor cleaning device 102 may be directly coupled to the one or more image capturing devices 104. In accordance with an embodiment, the floor cleaning device 102 may be communicatively coupled to the one or more image capturing devices 104. via a communication network. A user may be associated with the floor cleaning device 102.

In accordance with an embodiment, ultra-wide-angle fish eye lens cameras can be installed, on the floor cleaning device or vehicle sides at top edges of the vehicle body to enable maximum coverage around the vehicle.

The bird eye view generated by processing of each camera acts like a virtual top view camera that offers a top view of the floor level features, objects or defect. The area coverage of this virtual top camera view is directly proportional to the canvas area designated during image registration of the camera view.

The floor cleaning device 102 may include suitable logic, circuitry, interfaces, and/or code that may be configured to capture a plurality of images of a floor surface using one or more image capturing devices 104 mounted on exterior top sides of the floor cleaning device body aimed in a forward drive direction. In accordance with an embodiment, the plurality of images correspond to a plurality of wide-angle view images. In accordance with an embodiment, the floor cleaning device 102 may be configured to generate at least one undistorted virtual top view image of the floor surface using the plurality of images captured of the floor surface. In accordance with an embodiment, the at least one undistorted virtual top view image corresponds to a surround view image of the floor surface.

In accordance with an embodiment, the floor cleaning device 102 may be configured to detect at least one floor stain 106 from the at least one undistorted virtual top view image of the floor surface using a first pre-trained machine learning model. In accordance with an embodiment, a canvas area of the at least one undistorted virtual top view image has a predefined ratio relative to a floor area covered by the one or more image capturing devices. In accordance with an embodiment, the floor cleaning device 102 may be configured to process the at least one floor stain 106 to extract at least one floor stain attribute. In accordance with an embodiment, the at least one floor stain attribute comprises at least one of: dimensions of the floor stain 106, a floor stain type from a set of floor stain types, a distance of the at least one floor stain 106 from each of the one or more image capturing devices, and a location of the at least one floor stain 106 in the floor area. In accordance with an embodiment, the floor cleaning device 102 may be configured to cleaning the at least one floor stain 106 based on the processing of the least one floor stain 106.

Although in FIG. 1, the floor cleaning device 102 and the one or more image capturing devices 104 are shown as a single entity, this disclosure is not so limited. Accordingly, in some embodiments, the functionality of the image capturing devices 104 may not be included in the floor cleaning device 102 and act as two separate entities, without a deviation from scope of the disclosure.

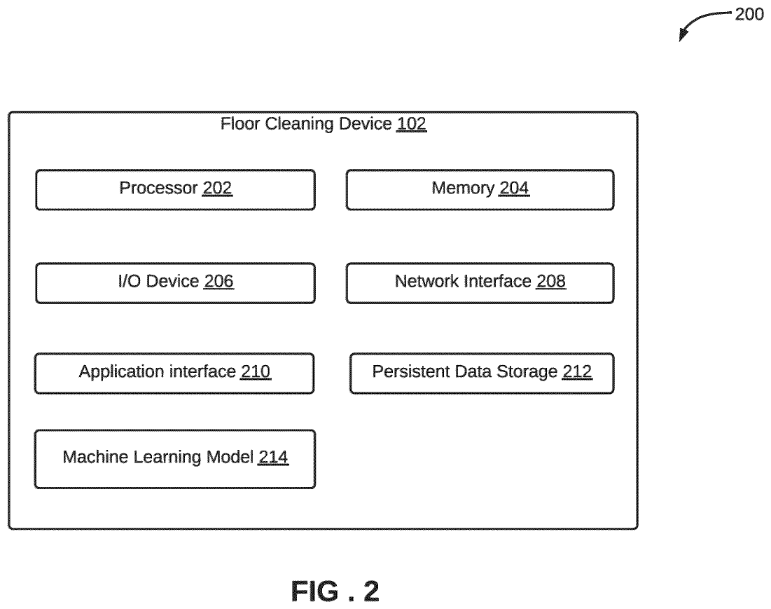

FIG. 2 is a functional block diagram of a floor cleaning device for detecting floor stains, in accordance with an embodiment of the present disclosure. FIG. 1 is explained in conjunction with elements from FIG. 2.

With reference to FIG. 2, the floor cleaning device 102 may include a processor 202, a memory 204, an input/output (I/O) device 206, a network interface 208, an application interface 210, and a persistent data storage 212. The floor cleaning device 102 may also include a machine learning model 214, as part of, for example, a software application for decisioning in performance of detection of floor stains in the floor cleaning device 102. The processor 202 may be communicatively coupled to the memory 204, the I/O device 206, the network interface 208, the application interface 210, and the persistent data storage 212. In one or more embodiments, the floor cleaning device 102 may also include a provision/functionality to receive image data via the image capturing devices 104.

The processor 202 may include suitable logic, circuitry, interfaces, and/or code that may be configured to train the machine/deep learning model for detecting floor stains. In accordance with an embodiment, the machine/deep learning model may be pre-trained for object detection, classification of floor stains into types and determining contours of the floor stain. Once trained, the machine/deep learning model may be either deployed on other electronic devices (e.g., a user device) or on the floor cleaning device 102 for real time floor stain detection of the image data from the image capturing devices 104 of the floor cleaning device 102. The processor 202 may be implemented based on a number of processor technologies, which may be known to one ordinarily skilled in the art. Examples of implementations of the processor 202 may be a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, Artificial Intelligence (AI) accelerator chips, a co-processor, a central processing unit (CPU), and/or a combination thereof.

The memory 204 may include suitable logic, circuitry, and/or interfaces that may be configured to store instructions executable by the processor 202. Additionally, the memory 204 may be configured to store image data (plurality of images) from the image capturing device 104, program code of the machine/deep learning model and/or the software application that may incorporate the program code of the machine learning model. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, and/or interfaces that may be configured to act as an I/O interface between a user and the floor cleaning device 102. The user may include an operator or janitor who operates the floor cleaning device 102. The I/O device 206 may include various input and output devices, which may be configured to communicate with different operational components of the floor cleaning device 102. Examples of the I/O device 206 may include, but are not limited to, a touch screen, a keyboard, a mouse, a joystick, a microphone, and a display screen.

The network interface 208 may include suitable logic, circuitry, interfaces, and/or code that may be configured to facilitate different components of the floor cleaning device 102 to communicate with other devices, such as a user device, via the communication network. The network interface 208 may be configured to implement known technologies to support wired or wireless communication. Components of the network interface 208 may include, but are not limited to an antenna, a radio frequency (RF) transceiver, one or more amplifiers, a tuner, one or more oscillators, a digital signal processor, a coder-decoder (CODEC) chipset, an identity module, and/or a local buffer.

The network interface 208 may be configured to communicate via offline and online wireless communication with networks, such as the Internet, an Intranet, and/or a wireless network, such as a cellular telephone network, a wireless local area network (WLAN), personal area network, and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VOIP), Wi-MAX, Internet-of-Things (IoT) technology, Machine-Type-Communication (MTC) technology, a protocol for email, instant messaging, and/or Short Message Service (SMS).

The application interface 210 may be configured as a medium for the user to interact with the floor cleaning device 102. The application interface 210 may be configured to have a dynamic interface that may change in accordance with preferences set by the user and configuration of the floor cleaning device 102. In some embodiments, the application interface 210 may correspond to a user interface of applications installed on the floor cleaning device 102.

The persistent data storage 212 may include suitable logic, circuitry, and/or interfaces that may be configured to store program instructions executable by the processor 202, operating systems, and/or application-specific information. The persistent data storage 212 may include a computer-readable storage media for carrying or having computer-executable instructions or data structures stored thereon. Such computer-readable storage media may include any available media that may be accessed by a general-purpose or special-purpose computer, such as the processor 202.

By way of example, and not limitation, such computer-readable storage media may include tangible or non-transitory computer-readable storage media including, but not limited to, Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 202 to perform a certain operation or a set of operations associated with the floor cleaning device 102. The functions or operations executed by the floor cleaning device 102, as described in FIG. 1, may be performed by the processor 202. In accordance with an embodiment, additionally, or alternatively, the operations of the processor 202 are performed by various modules of the floor cleaning device 102.

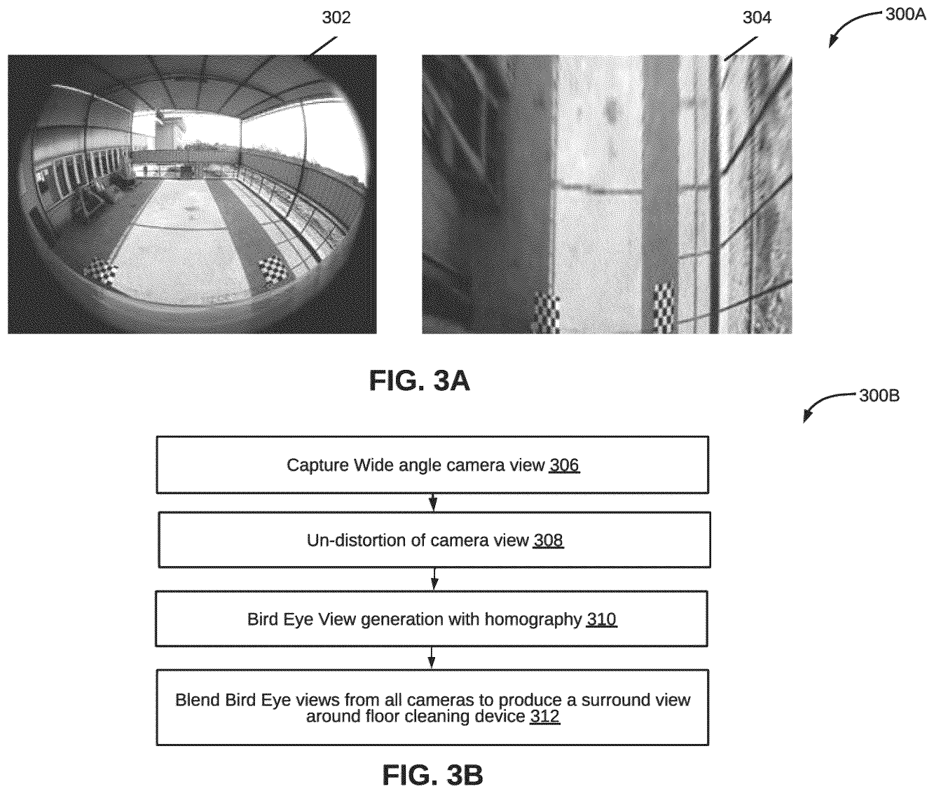

FIG. 3A-3B illustrate an exemplary scenario of capturing plurality of wide-angle view images and generating undistorted virtual top view image of the floor surface for detecting floor stains, in accordance with an embodiment of the present disclosure.

Referring to FIG. 3A, a wide-angle view of the object scene 302 is captured by employing a low-cost fish eye CMOS camera of maximum Field of View (FOV) such as 180-degree mounted at the front edge of the floor cleaning device 102 (also referred as the vehicle). In accordance with an embodiment, the floor cleaning device 102 may be configured to generate an undistorted virtual top view (Bird Eye View) camera image 304 with a range. The left and right boundaries of undistorted virtual top view is parallel to each other, hence making it reliable to measure distance to objects up to a certain range without distortion. By way of an example, the floor cleaning device 102 may be configured to employ a partial (single or two camera) Bird eye view of a surround view system on the vehicle to detect and identify floor stains by employing bird eye views of a camera-based surround view system using a unique combination of computer vision and artificial intelligence.

In accordance with an embodiment, the bird eye view created from each camera view gives “true view” of the floor level defect or floor stain. In accordance with an embodiment, generation of the bird eye view in a surround view uses ground level surface image registration and therefore perspective transformed image produces a bird eye view or a “virtual top camera” of the ground level in real dimensions as shown in FIG. 3A.

With reference to FIG. 3B, a flowchart for detecting floor stain using surround view system with bird eye views is shown. The camera view images are derived (306) from each of the ultra-wide-angle cameras mounted around the floor cleaning device 102 (or vehicle) and also displayed on the display monitor. In accordance with an embodiment, the surround view system of the floor cleaning device may perform un-distortion (308), homography (310), bird eye view transformation and blending (312).

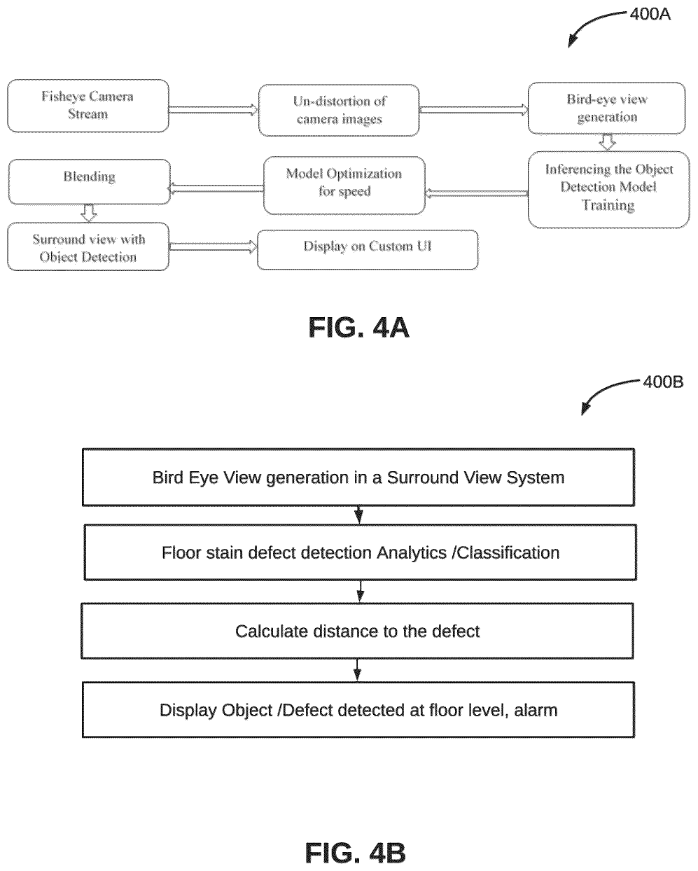

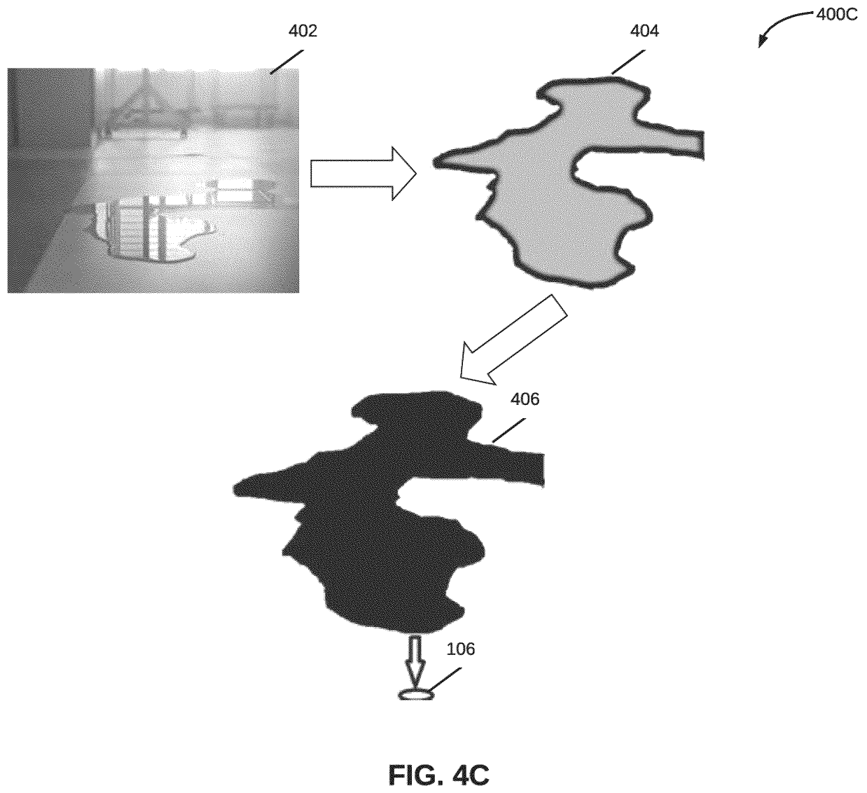

FIG. 4A-4C collectively illustrate an exemplary scenario of floor cleaning device used for extracting floor stain attributes, in accordance with an embodiment of the present disclosure.

In accordance with an embodiment, a block diagram 400A is illustrated to detect and analyze floor stains in a bird eye view images in a multi-camera-based surround view system.

In the case of detecting floor stains, there are at least two important aspects that may be important: firstly, to identify type of floor stain, secondly, to detect exact location of the floor stain and its distance from the vehicle and thirdly the dimensions of the floor stain. The key is to detect and identify a floor stain in the first place. Once identified, the dimensions of the floor stain can be extracted.

The floor cleaning device may provide object detection and identification by subjecting the virtual top view or bird eye view of a surround view system that gives a top view of the floor stain to a deep convolutional network-based object detection model inferencing. Any state-of-the-art deep convolutional network can be used as in some implementations of reliable object detection from aerial views from drones. In accordance with an embodiment, the floor cleaning device implemented object detection & recognition detector model using Yolo V2 architecture.

The floor stains in the bird eye view images can be annotated as ground truths using a suitable annotation tool and are used to train an object recognition model. Once trained, the same model can be used to derive inferences of floor stain detection.

In some embodiments, the object analytics of the floor cleaning device on bird eye view images can perform segmentation deep learning segmentation methods, such as, Semantic Segmentation to get reliable contours of floor stains. Semantic Segmentation techniques such as Mask RCNN or U-net can be used.

With reference to FIG. 4B, there is shown a flowchart 400B for classification of floor stains by floor cleaning device using a suitable method of clustering.

In accordance with an embodiment, Support Vector Machine (SVM) based classification model may be used by the floor cleaning device 102. Once recognized, the floor stains may be localized by bounding box to mark the boundaries of the floor stain in pixel coordinates. The recognized floor stain is localized back or written to the bird eye view image with its pixel boundaries. It is important to ensure accuracy of dimensions of the floor stain. This is possible by generating the virtual top view from the floor cleaning device by surround view being reliably capturing floor stains. This is reliable since image view registration in the surround view process is done at the floor level within a specified range around the floor cleaning device 102 (or the vehicle).

With reference to FIG. 4C, there is shown representative pictures 402 (Camera view of floor stain), 404 (Bird Eye view of the floor stain), and 406 (Distance detected to floor stain identified from the camera edge) of the detected floor stain in Bird Eye View.

To aid in the cleaning process of the floor cleaning device, it is important to identify distance of the floor stain from the floor cleaning device. Assuming the camera is mounted on the exteriors of the floor cleaning device 102 or the vehicle in a front-looking position, the distance from the bottom edge of the bird eye view image to the lower edge of the floor stain detected pixel boundaries or bounding box is derived in pixels. Assuming the pixels are calibrated to real world distances with respect to camera calibration etc., the distance to the floor stain can be detected in real world units, such as, but not limited to, millimeters and centimeters.

In accordance with an embodiment, the floor cleaning device 102 may be configured to detect and recognize objects, humans around the floor cleaning device 102 or the vehicle in surround view and detect distances to them. When these objects are closer to the floor cleaning device 102 or the vehicle within a safe zone or too close to the floor cleaning device 102 or the vehicle, the floor cleaning device may be configured to raise alert. The vehicle may correspond to off-highway vehicles such as excavators and boom lifts.

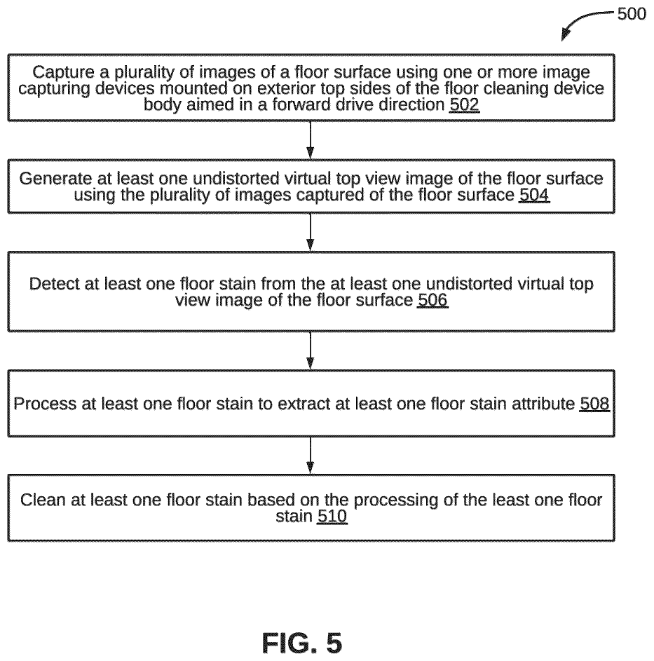

FIG. 5 is a flowchart that illustrates an exemplary method for detecting floor stains using surround view images, in accordance with an embodiment of the present disclosure. The control starts at step 502 and proceeds to step 504.

At step 502, a plurality of images of a floor surface may be captured using one or more image capturing devices. In accordance with an embodiment, the floor cleaning device 102 may be configured to capture a plurality of images of a floor surface using one or more image capturing devices mounted on exterior top sides of the floor cleaning device body aimed in a forward drive direction. In accordance with an embodiment, the plurality of images correspond to a plurality of wide-angle view images.

At step 504, at least one undistorted virtual top view image of the floor surface may be generated using the plurality of images captured of the floor surface. In accordance with an embodiment, the floor cleaning device 102 may be configured to generating at least one undistorted virtual top view image of the floor surface using the plurality of images captured of the floor surface, wherein the at least one undistorted virtual top view image corresponds to a surround view image of the floor surface.

At step 506, at least one floor stain may be detected from the at least one undistorted virtual top view image of the floor surface. In accordance with an embodiment, the floor cleaning device 102 may be configured to detecting at least one floor stain from the at least one undistorted virtual top view image of the floor surface using a first pre-trained machine learning model. In accordance with an embodiment, a canvas area of the at least one undistorted virtual top view image has a predefined ratio relative to a floor area covered by the one or more image capturing devices.

At step 508, at least one floor stain may be processed to extract at least one floor stain attribute. In accordance with an embodiment, the floor cleaning device 102 may be configured to processing the at least one floor stain to extract at least one floor stain attribute. In accordance with an embodiment, the at least one floor stain attribute comprises at least one of: dimensions of the floor stain, a floor stain type from a set of floor stain types, a distance of the at least one floor stain from each of the one or more image capturing devices, and a location of the at least one floor stain in the floor area.

At step 510, at least one floor stain may be cleaned. In accordance with an embodiment, the floor cleaning device 102 may be configured to cleaning the at least one floor stain based on the processing of the least one floor stain.

Exemplary aspects of the disclosure may provide a plurality of image capturing devices (such as, 3-camera system) that generates Bird Eye View with 180-degree Coverage each camera. In accordance with an embodiment, the Bird Eye View enables to see the defects, stains on floor surface in true dimensions (such as, cm, mm) and compute distance between the floor stain and camera. In accordance with an embodiment, defects, and stains on the floor surface can be analyzed by the floor cleaning device with Surround View images using object analytics for classification. The disclosed floor cleaning device may increase work efficiency in floor cleaning device and also automate some of the work in floor cleaning by reliably identifying floor stain defects left over by operator or human errors.

It is intended that the disclosure and examples be considered as exemplary only, with a true scope and spirit of disclosed embodiments being indicated by the following claims.

We claim:

1. A method for detecting a floor stain, the method comprising:
capturing, by a floor cleaning device, a plurality of images of a floor surface using one or more image capturing devices mounted on exterior top sides of the floor cleaning device body aimed in a forward drive direction, wherein the plurality of images correspond to a plurality of wide-angle view images;
generating, by the floor cleaning device, at least one undistorted virtual top view image of the floor surface using the plurality of images captured of the floor surface, wherein the at least one undistorted virtual top view image corresponds to a surround view image of the floor surface;
detecting, by the floor cleaning device, at least one floor stain from the at least one undistorted virtual top view image of the floor surface using a first pre-trained machine learning model, wherein a canvas area of the at least one undistorted virtual top view image has a predefined ratio relative to a floor area covered by the one or more image capturing devices; and
processing, by the floor cleaning device, the at least one floor stain to extract at least one floor stain attribute from one or more floor stain attributes,
wherein the one or more floor stain attributes comprise: dimensions of the floor stain, a floor stain type from a set of floor stain types, a distance of the at least one floor stain from each of the one or more image capturing devices, and a location of the at least one floor stain in the floor area.

2. The method of claim 1, wherein generating the surround view image of the floor surface further comprises:
generating a plurality of bird eye view images from the plurality of wide-angle view images; and
blending the plurality of bird eye view images to generate the surround view image of the floor surface, wherein the surround view image of the floor surface facilitates distance calculation between the floor cleaning device and the floor stain in a metric unit, and wherein the metric unit corresponds to one of: centimeter, millimeter and meter unit.

3. The method of claim 1, wherein the first pre-trained machine learning model corresponds to an object detection based Convolutional Neural Network (CNN) model.

4. The method of claim 1, wherein the floor stain type is extracted from the set of floor stain types using a second pre-trained machine/deep learning model, wherein the second pre-trained machine learning model corresponds to a Support Vector Machine (SVM) classification-based machine learning model.

5. The method of claim 1, further comprising
identifying a pixel boundary of the at least one floor stain in the surround view image of the floor surface in pixels for locating the at least one stain, wherein the pixels of the pixel boundary in the surround view image are calibrated to a real world distance with respect to calibration of each of the one or more image capturing devices; and
calculating the distance between the bottom edge of the surround view image and the lower edge of the pixel boundary of the at least one floor stain, wherein the distance is calculated in pixels.

6. The method of claim 1, further comprising
detecting an object in surround view image corresponding to vicinity of the floor cleaning device;
processing the object to extract at least one object attribute, wherein the object attribute comprises at least one of: a type of object and distance of the object from each of the one or more image capturing devices; and
generate an alarm, based on the distance of the object from each of the one or more image capturing devices above a predefined threshold value.

7. The method of claim 1, further comprising cleaning the at least one floor stain based on the processing of the least one floor stain.
